(19) United States
(12) Patent Application Publication
(10) Pub. No.: US 2019/0301414 A1
(43) Pub. Date: Oct. 3, 2019

(54) High-Pressure Fuel Supply Pump

(71) Applicant: Hitachi Automotive Systems, Ltd., Hitachinaka-shi, lbaraki (JP)

(72) Inventors: Satoshi USUI, Hitachinaka-shi (JP); Atsuji SAITO, Hitachinaka-shi (JP); Minoru HASHIDA, Hitachinaka-shi (JP); Masamichi YAGAI, Hitachinaka-shi (JP); Kenichiro TOKUO, Hitachinaka-shi (JP); Masayuki SUGANAMI, Hitachinaka-shi (JP); Masahiko HAYATANI, Hitachinaka-shi (JP); Hiroyuki YAMADA, Hitachinaka-shi (JP)

(21) Appl. No.: 16/304,537

(22) PCT Filed: Apr. 11, 2017
(86) PCT No.: PCT/JP2017/014771

§ 371 Date: Nov. 26, 2018

(30) Foreign Application Priority Data
May 27, 2016 (JP) 2016-105760

(51) Int. Cl. F02M 59/34; F02M 59/20

(52) U.S. Cl. CPC F02M 59/34; F02M 59/20

(57) ABSTRACT

Provided is a high-pressure fuel supply pump capable of arranging a relief valve mechanism inside a pump body while suppressing an increase in size and an increase in manufacturing cost. Therefore, a high-pressure fuel supply pump of the present invention includes: a plunger that changes a volume of a pressurizing chamber by reciprocating an inside of a cylinder; a first hole formed from an outer circumferential surface of a pump body toward an inner circumferential side; a relief valve mechanism arranged in the first hole; and a second hole that returns fuel in a flow path on a discharge side of a discharge valve pressurized in the pressurizing chamber to a damper chamber or a plunger seal chamber communicating with the damper chamber when the relief valve mechanism opens in communication with the first hole. At least a part of the relief valve mechanism arranged in the first hole is arranged on the pressurizing chamber side with respect to the uppermost end portion on the pressurizing chamber side of the cylinder.

### TECHNICAL FIELD

The present invention relates to a high-pressure fuel supply pump that pumps fuel to a fuel injection valve of an internal combustion engine, and more particularly to an arrangement of a relief valve that releases an abnormally high pressure fuel generated due to a failure of a high-pressure fuel supply pump to a low pressure side.

### BACKGROUND ART

An example of a conventional technique of a high-pressure fuel pump according to the present invention is described in PTL 1. According to PTL 1, a size of a relief valve increases along with an increase in pressure of pressurized fuel. Since this large-size relief valve is installed inside a discharge joint, a structure is realized in which a size of the high-pressure fuel pump for high pressure is not increased even if the pressure of the pressurized fuel is increased. With the relief valve, an abnormally high pressure fuel is returned to a pressurizing chamber or a low pressure chamber.

### CITATION LIST

### Patent Literature

PTL 1: WO 2015/163245

### SUMMARY OF INVENTION

### Technical Problem

As the pressure of the pressurized fuel increases, a return destination of the abnormally high pressure fuel is desirably set to not the pressurizing chamber but the low pressure chamber. In FIG. 7 of the above-described PTL 1, the relief valve is arranged in the discharge joint. The abnormally high pressure fuel generated due to a failure of the high-pressure fuel supply pump or the like is released to a damper chamber on a low pressure side.

The relief valve is press-fitted and fixed to a pump body. However, there is a problem that a diameter of the pump body becomes large so that the size thereof in the vertical direction becomes large due to a problem in terms of layout. In addition, there is a problem that handling of a fuel passage inside the pump body becomes complicated and processing becomes complicated and cost increases.

Therefore, an object of the present invention is to provide a high-pressure fuel supply pump capable of arranging a relief valve mechanism inside a pump body while suppressing an increase in size and an increase in manufacturing cost.

### Solution to Problem

In order to achieve the above object, a high-pressure fuel supply pump of the present invention includes: a plunger that changes a volume of a pressurizing chamber by reciprocating an inside of a cylinder; a first hole formed from an outer circumferential surface of a pump body toward an inner circumferential side; a relief valve mechanism arranged in the first hole; and a second hole that returns fuel in a flow path on a discharge side of a discharge valve pressurized in the pressurizing chamber to a damper chamber or a plunger seal chamber communicating with the damper chamber when the relief valve mechanism opens in communication with the first hole. At least a part of the relief valve mechanism arranged in the first hole is arranged on the pressurizing chamber side with respect to the uppermost end portion on the pressurizing chamber side of the cylinder.

### Advantageous Effects of Invention

According to the present invention, it is possible to provide the high-pressure fuel supply pump in which the relief valve is arranged inside the pump body while suppressing the increase in size and the increase in manufacturing cost.

Other configurations, operations, and effects of the present invention will be described in detail in the following embodiments.

### BRIEF DESCRIPTION OF DRAWINGS

FIG. 1 is a vertical cross-sectional view of a high-pressure fuel supply pump according to a first embodiment of the present invention.

FIG. 2 is a horizontal cross-sectional view of the high-pressure fuel supply pump according to the first embodiment of the present invention as viewed from above.

FIG. 3 is a vertical cross-sectional view of the high-pressure fuel supply pump according to the first embodiment of the present invention as viewed from a different direction from FIG. 1.

FIG. 4 is an enlarged vertical cross-sectional view of an electromagnetic intake valve mechanism of the high-pressure fuel supply pump according to the first embodiment of the present invention, which illustrates a state where the electromagnetic intake valve mechanism is in an open valve state.

FIG. 5 illustrates a configuration diagram of an engine system to which a high-pressure fuel supply pump according to the first or a second embodiment of the present invention is applied.

FIG. 6 is a vertical cross-sectional view of the high-pressure fuel supply pump according to the second embodiment of the present invention.

FIG. 7 is a horizontal cross-sectional view of the high-pressure fuel supply pump according to the second embodiment of the present invention as viewed from above.

FIG. 8 is a vertical cross-sectional view of the high-pressure fuel supply pump according to the second embodiment of the present invention as viewed from a different direction from FIG. 6.

FIG. 9 is a vertical cross-sectional view of a high-pressure fuel supply pump according to a third embodiment of the present invention.

FIG. 10 illustrates a configuration diagram of an engine system to which a high-pressure fuel supply pump according to the third or a fourth embodiment of the present invention is applied.

FIG. 11 is a vertical cross-sectional view of the high-pressure fuel supply pump according to the fourth embodiment of the present invention.

FIG. 12 is a vertical cross-sectional view of a high-pressure fuel supply pump according to a fifth embodiment of the present invention.

### DESCRIPTION OF EMBODIMENTS

Hereinafter, embodiments of the present invention will be described with reference to the drawings.

### First Embodiment

First, a first embodiment of the present invention will be described in detail with reference to the drawings.

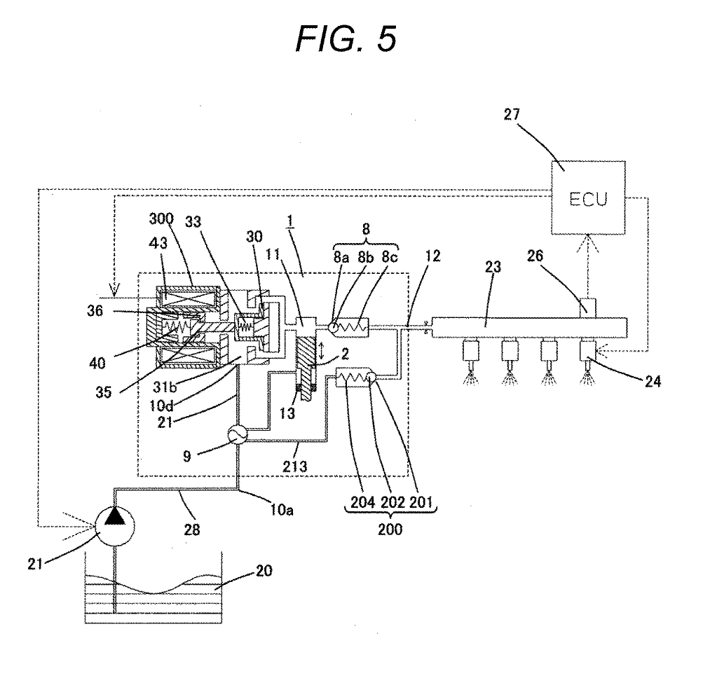

FIG. 5 illustrates an overall configuration diagram of an engine system. A portion surrounded by a broken line indicates a main body of a high-pressure fuel supply pump (hereinafter referred to as a pump body), and mechanisms and parts illustrated in this broken line are integrally incorporated in a pump body 1.

Fuel in a fuel tank 20 is pumped up by a feed pump 21 based on a signal from an engine control unit 27 (hereinafter referred to as the ECU). This fuel is pressurized to an appropriate feed pressure and sent to a low-pressure fuel intake port 10a of the high-pressure fuel supply pump through a suction pipe 28.

The fuel having passed through an intake joint 51 from the low-pressure fuel intake port 10a reaches an intake port 31b of an electromagnetic intake valve mechanism 300 forming a capacity variable mechanism via a pressure pulsation reduction mechanism 9 and an intake passage 10d.

The fuel flowing into the electromagnetic intake valve mechanism 300 passes through the intake port to be opened and closed by an intake valve 30 and flows into a pressurizing chamber 11. A cam mechanism 93 of the engine applies motive power for a reciprocating motion to a plunger 2. Due to the reciprocating motion of the plunger 2, fuel is sucked from the intake valve 30 in a descending stroke of the plunger 2, and the fuel is pressurized in an ascending stroke thereof. Fuel is pumped through a discharge valve mechanism 8 to a common rail 23 to which a pressure sensor 26 is mounted. An injector 24 injects fuel to the engine based on a signal from the ECU 27. The present embodiment relates to a high-pressure fuel supply pump which is applied to a so-called direct injection engine system in which the injector 24 injects fuel directly into a cylinder barrel of the engine.

The high-pressure fuel supply pump discharges fuel of a desired supplied flow rate based on the signal from the ECU 27 to the electromagnetic intake valve mechanism 300.

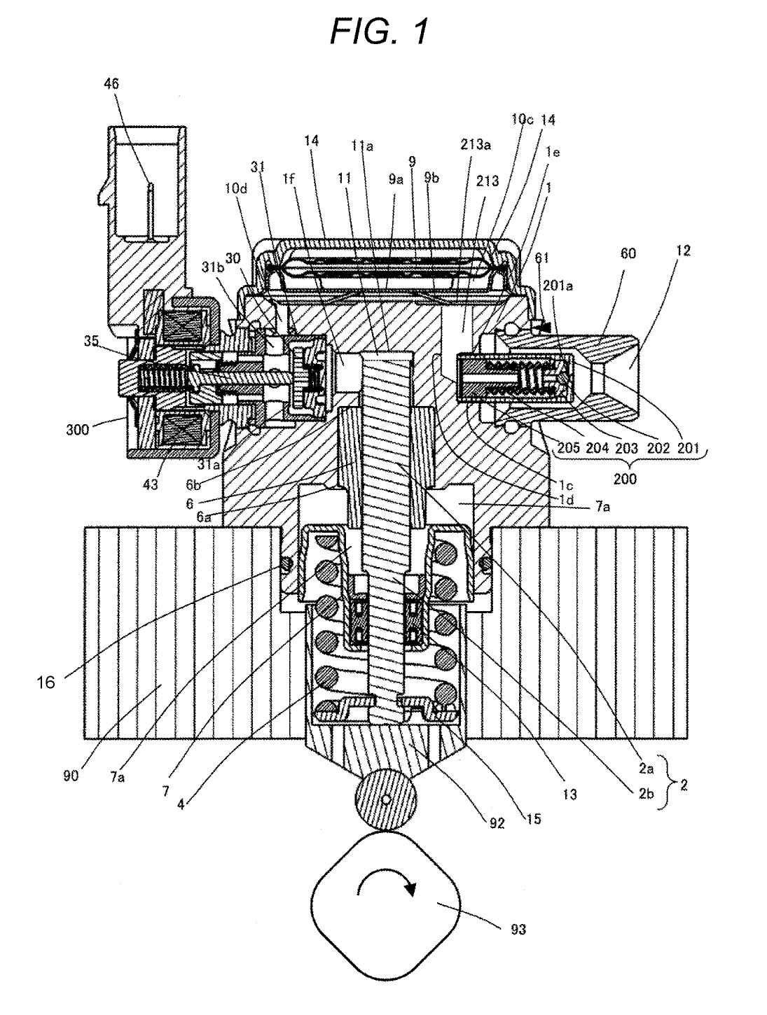

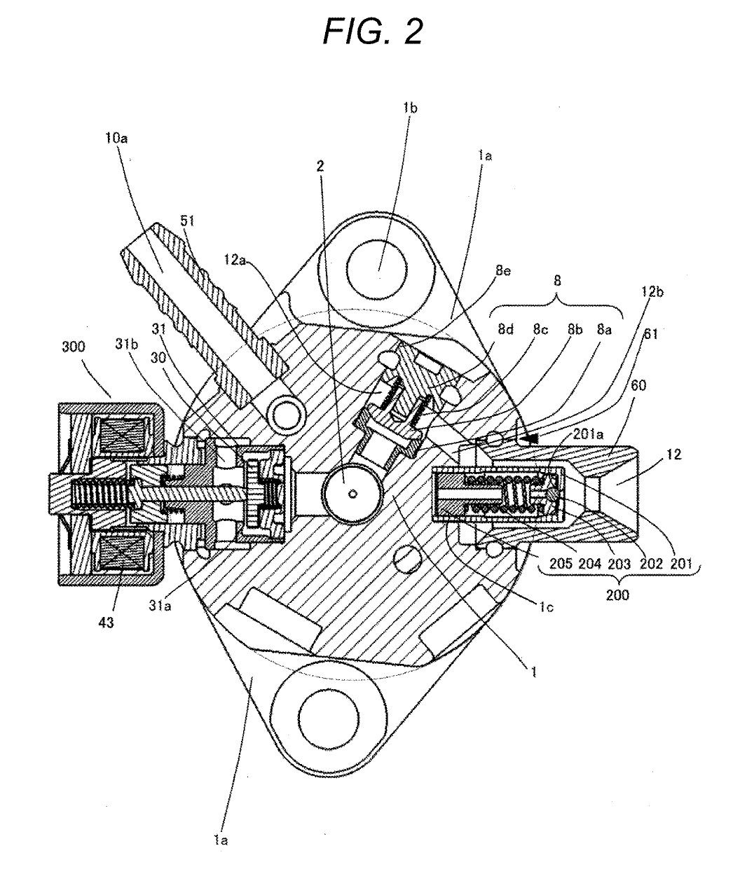

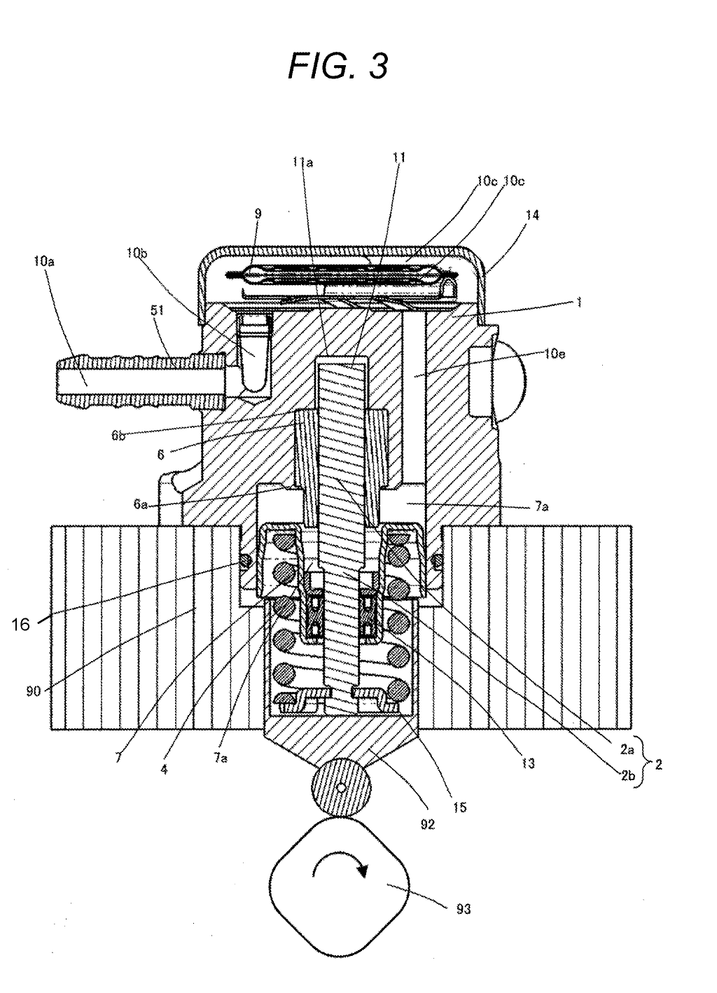

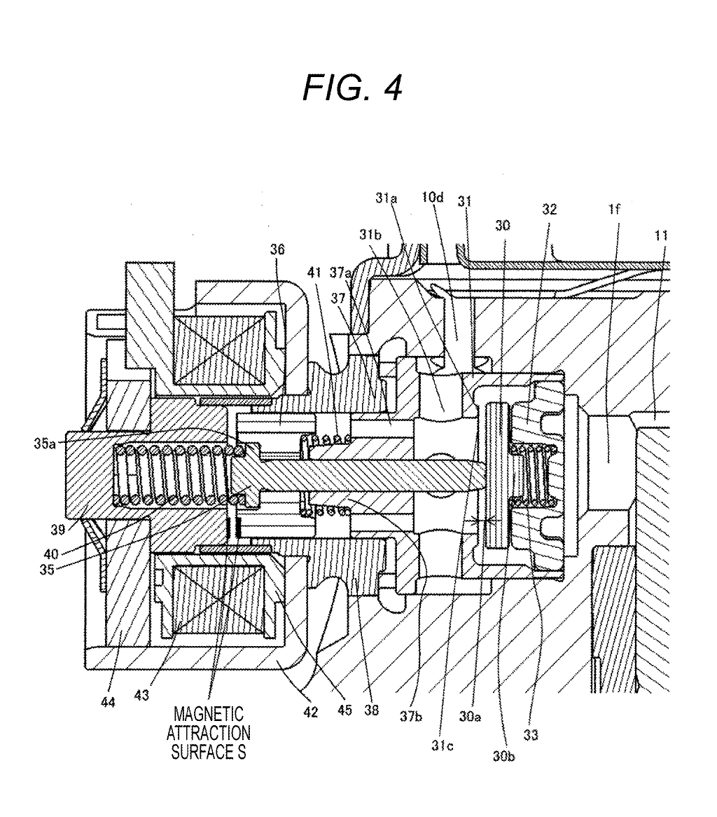

FIG. 1 is a vertical cross-sectional view of the high-pressure fuel supply pump of the present embodiment, and FIG. 2 is a horizontal cross-sectional view of the high-pressure fuel supply pump as viewed from above. Further, FIG. 3 is a vertical cross-sectional view of the high-pressure fuel supply pump as viewed from a different direction from FIG. 1. FIG. 4 is an enlarged view of the electromagnetic intake valve mechanism 300.

As illustrated in FIGS. 1 and 3, the high-pressure fuel supply pump of the present embodiment is fixed in close contact with a high-pressure fuel supply pump mounting portion 90 of an internal combustion engine. More specifically, screw holes 1b are formed in a mounting flange 1a provided in the pump body 1 of FIG. 2, and the mounting flange 1a is brought into close contact with and fixed to the high-pressure fuel supply pump mounting portion 90 of the internal combustion engine by inserting a plurality of bolts into the screw holes.

In order for seal between the high-pressure fuel supply pump mounting portion 90 and the pump body 1, an O-ring 16 is fitted into the pump body 1 to prevent engine oil from leaking to the outside.

A cylinder 6, which guides the reciprocating motion of the plunger 2 and forms the pressurizing chamber 11 together with the pump body 1, is mounted to the pump body 1. That is, the plunger 2 reciprocates inside the cylinder to change the volume of the pressurizing chamber. Further, the electromagnetic intake valve mechanism 300 configured to supply fuel to the pressurizing chamber 11 and the discharge valve mechanism 8 configured to discharge the fuel from the pressurizing chamber 11 to a discharge passage are provided.

The cylinder 6 is press-fitted into the pump body 1 on an outer circumferential side thereof. Further, the body is deformed toward an inner circumferential side at a fixing portion 6a to push the cylinder upward in the drawing and sealing is performed so that the fuel pressurized in the pressurizing chamber 11 at an upper end face of the cylinder 6 does not leak to a low pressure side.

A tappet 92, which converts a rotational motion of the cam 93 attached to a camshaft of the internal combustion engine into an up-and-down motion and transmits the converted motion to the plunger 2, is provided at a lower end of the plunger 2. The plunger 2 is crimped to the tappet 92 by a spring 4 via a retainer 15. As a result, the plunger 2 can reciprocate up and down along with the rotational motion of the cam 93.

Further, the plunger seal 13 held at a lower end portion of an inner circumference of a seal holder 7 is installed in the state of being slidably in contact with an outer circumference of the plunger 2 in a lower portion of the cylinder 6 in the drawing. As a result, when the plunger 2 slides, the fuel of an auxiliary chamber 7a is sealed to be prevented from flowing into the internal combustion engine. At the same time, lubricating oil (including engine oil) lubricating a sliding portion in the internal combustion engine is prevented from flowing into the pump body 1.

As illustrated in FIGS. 2 and 3, the intake joint 51 is attached to a side surface portion of the pump body 1 of the high-pressure fuel supply pump. The intake joint 51 is connected to a low-pressure pipe that supplies fuel from the fuel tank 20 of a vehicle, and the fuel is supplied to the inside of the high-pressure fuel supply pump from the intake joint 51. An intake filter 52 serves to prevent foreign matters present between the fuel tank 20 and the low-pressure fuel intake port 10a from being absorbed into the high-pressure fuel supply pump by the flow of fuel.

The fuel that has passed through the low-pressure fuel intake port 10a passes through a low-pressure fuel intake port 10b vertically communicating with the pump body 1 illustrated in FIG. 2 and flows toward the pressure pulsation reduction mechanism 9. The pressure pulsation reduction mechanism 9 is arranged between a damper cover 14 and an upper end face of the pump body 1 and is supported from the lower side by a holding member 9a arranged on the upper end face of the pump body 1. More specifically, the pressure pulsation reduction mechanism 9 is formed by superimposing two diaphragms on each other, and a gas is enclosed in the inside of the pressure pulsation reduction mechanism 9 at 0.3 MPa to 0.6 MPa, and an outer circumferential edge portion thereof is fixed by welding. Thus, the pressure pulsation reduction mechanism 9 is configured to be thin in the outer circumferential edge portion and become thicker toward the inner circumferential side.

Further, a convex portion configured to fix the outer edge portion of the pressure pulsation reduction mechanism 9 from the lower side is formed on an upper surface of the holding member 9a. On the other hand, a convex portion configured to fix the outer circumferential edge portion of the pressure pulsation reduction mechanism 9 from the upper side is formed on a lower surface of the damper cover 14. These convex portions are formed in a circular shape, and the pressure pulsation reduction mechanism 9 is fixed by being sandwiched by these convex portions. Incidentally, the damper cover 14 is press-fitted and fixed to the outer edge portion of the pump body 1, and at this time, the holding member 9a is elastically deformed to support the pressure pulsation reduction mechanism 9. In this manner, the damper chamber 10c communicating with the low-pressure fuel intake ports 10a and 10b is formed on the upper and lower surfaces of the pressure pulsation reduction mechanism 9.

Although not illustrated in the drawing, a passage is formed in the holding member 9a to communicate the upper side with the lower side of the pressure pulsation reduction mechanism 9, and as a result, the damper chamber 10c is formed on the upper and lower surfaces of the pressure pulsation reduction mechanism 9.

The fuel that has passed through the damper chamber 10c then reaches an intake port 31b of the electromagnetic intake valve mechanism 300 via a low-pressure fuel flow path 10d formed to communicate with the pump body in the vertical direction. Incidentally, the intake port 31b is formed to communicate with an intake valve seat member 31 forming an intake valve seat 31a in the vertical direction.

As illustrated in FIG. 2, the discharge valve mechanism 8 provided at an outlet of the pressurizing chamber 11 is constituted by a discharge valve seat 8a, a discharge valve 8b which is brought into contact with or separated from the discharge valve seat 8a, a discharge valve spring 8c biasing the discharge valve 8b toward the discharge valve seat 8a, and a discharge valve stopper 8d defining a stroke (movement distance) of the discharge valve 8b. The discharge valve stopper 8d and the pump body 1 are joined to each other at an abutment portion 8e by welding to shut off the fuel from the outside.

In a state where there is no pressure difference of fuel between the pressurizing chamber 11 and a discharge valve chamber 12a, the discharge valve 8b is pressed against the discharge valve seat 8a by a biasing force generated by the discharge valve spring 8c and is turned into a closed valve state. The discharge valve 8b opens against the discharge valve spring 8c only when the fuel pressure in the pressurizing chamber 11 becomes larger than the fuel pressure in the discharge valve chamber 12a. Further, the high-pressure fuel in the pressurizing chamber 11 is discharged to the common rail 23 via the discharge valve chamber 12a, the fuel discharge passage 12b, and the fuel discharge port 12. When opening, the discharge valve 8b is brought into contact with the discharge valve stopper 8d, and the stroke is restricted. Therefore, the stroke of the discharge valve 8b is appropriately determined by the discharge valve stopper 8d. As a result, it is possible to prevent the fuel discharged at a high pressure into the discharge valve chamber 12a from flowing back into the pressurizing chamber 11 again because the stroke becomes too large and the discharge valve 8b is closed late, and it is possible to suppress deterioration in efficiency of the high-pressure fuel supply pump. In addition, the discharge valve 8b is guided along an outer circumferential surface of the discharge valve stopper 8d such that the discharge valve 8b moves only in the stroke direction at the time of repeatedly moving to open and be closed. In this manner, the discharge valve mechanism 8 serves as a check valve that restricts a flowing direction of the fuel.

As described above, the pressurizing chamber 11 is constituted by the pump housing 1, the electromagnetic intake valve mechanism 300, the plunger 2, the cylinder 6, and the discharge valve mechanism 8.

FIG. 4 illustrates a detailed configuration of the electromagnetic intake valve mechanism 300. When the plunger 2 moves in the direction of the cam 93 by the rotation of the cam 93 and is in a suction stroke state, the volume of the pressurizing chamber 11 increases so that the fuel pressure in the pressurizing chamber 11 decreases. In this stroke, when the fuel pressure in the pressurizing chamber 11 becomes lower than the pressure of the intake port 31b, the intake valve 30 is turned into the open valve state. A maximum opening degree is indicated by 30a, and at this time, the intake valve 30 is brought into contact with a stopper 32. When the intake valve 30 opens, an opening portion 31c formed in the seat member 31 opens. The fuel passes through the opening portion 31c and flows into the pressurizing chamber 11 via a hole 1f formed in the pump body 1 in the lateral direction. Incidentally, the hole 1f also forms a part of the pressurizing chamber 11.

After the plunger 2 finishes the intake stroke, the plunger 2 turns to upward movement and shifts to the ascending stroke. Here, the electromagnetic coil 43 is maintained in a non-energized state, and a magnetic biasing force does not act. A rod biasing spring 40 biases a rod convex portion 35a which is convex toward an outer diameter side of a rod 35 and is set so as to have a biasing force necessary and sufficient for keeping the intake valve 30 open in the non-energized state. Although the volume of the pressurizing chamber 11 decreases along with the upward movement of the plunger 2, the fuel, once taken into the pressurizing chamber 11, returns to the intake passage 10d through the opening portion 30a of the intake valve 30 in the open valve state again in this state, the pressure of the pressurizing chamber does not increase. This stroke is referred to as a return stroke.

In this state, when a control signal from the engine control unit 27 (hereinafter referred to as the ECU) is applied to the electromagnetic intake valve mechanism 300, a current flows through a terminal 46 to the electromagnetic coil 43. A magnetic attractive force acts between a magnetic core 39 and an anchor 36 so that the magnetic core 39 and the anchor 36 are brought into contact with a magnetic attraction surface S. The magnetic attractive force overcomes the biasing force of the rod biasing spring 40 to bias the anchor 36, and the anchor 36 is engaged with the rod convex portion 35a to move the rod 35 in a direction away from the intake valve 30.

At this time, the intake valve 30 is closed by a biasing force of an intake valve biasing spring 33 and a fluid force generated by the fuel flowing into the intake passage 10d. After the valve is closed, the fuel pressure of the pressurizing chamber 11 increases along with the upward movement of the plunger 2 to be equal to or higher than the pressure of the fuel discharge port 12, the fuel is discharged at a high pressure through the discharge valve mechanism 8 and is supplied to the common rail 23. This stroke is referred to as a discharge stroke.

That is, the ascending stroke between a lower start point and an upper start point of the plunger 2 includes the return stroke and the discharge stroke. Then, it is possible to control the amount of the high-pressure fuel to be discharged by controlling a timing of energization to the coil 43 of the electromagnetic intake valve mechanism 300. When the electromagnetic coil 43 is energized at an early timing, the proportion of the return stroke is small and the proportion of the discharge stroke is large during a compression stroke. That is, the amount of fuel returning to the intake passage 10d is small, and the amount of fuel to be discharged at a high pressure becomes large. On the other hand, if the energization timing is delayed, the proportion of the return stroke is large and the proportion of the discharge stroke is small during the compression. That is, the amount of fuel returning to the intake passage 10d is large, and the amount of fuel to be discharged at a high pressure becomes small. The energization timing to the electromagnetic coil 43 is controlled by a command from the ECU 27. By controlling the energization timing to the electromagnetic coil 43 as described above, it is possible to control the amount of fuel to be discharged at a high pressure to the amount required by the internal combustion engine.

A low-pressure fuel chamber 10 is provided with the pressure pulsation reduction mechanism 9 that reduces the influence of pressure pulsation, generated in the high-pressure fuel supply pump, to the fuel pipe 28. When the fuel, which has once flown into the pressurizing chamber 11, is returned to the intake passage 10d again through the intake valve body 30 that is in the open valve state for capacity control, the pressure pulsation occurs in the low-pressure fuel chamber 10 due to the fuel returned to the intake passage 10d. However, the pressure pulsation reduction mechanism 9 provided in the low-pressure fuel chamber 10 is formed of a metal diaphragm damper, which is formed by affixing two corrugated disk-shaped metal plates together at outer circumferences thereof and injecting an inert gas such as argon into the inside thereof, and the pressure pulsation is reduced by absorption by expansion and contraction of this metal damper.

The plunger 2 has a large-diameter portion 2a and a small-diameter portion 2b, and the volume of the auxiliary chamber 7a is increased or decreased by the reciprocating motion of the plunger. The auxiliary chamber 7a communicates with the low-pressure fuel chamber 10 through a fuel passage 10e. The flow of fuel is generated from the auxiliary chamber 7a to the low-pressure fuel chamber 10 when the plunger 2 descends, and is generated from the low-pressure fuel chamber 10 to the auxiliary chamber 7a when the plunger 2 ascends.

As a result, it is possible to reduce a fuel flow rate to the inside or outside of the pump in the intake stroke or return stroke of the pump so as to serve a function of reducing the pressure pulsation that occurs inside the high-pressure fuel supply pump.

Next, the relief valve mechanism 200 illustrated in FIGS. 1 and 2 will be described.

The relief valve mechanism 200 is constituted by a relief body 201, a relief valve 202, a relief valve holder 203, a relief spring 204, and a spring stopper 205. The relief body 201 is provided with a tapered seat portion 201a. As a load of the relief spring 204 is loaded via the valve holder 203, the valve 202 is pressed against the seat portion 201a to shut off the fuel in cooperation with the seat portion 201a. A valve-opening pressure of the relief valve 202 is determined by the load of the relief spring 204. The spring stopper 205 is a mechanism that is press-fitted and fixed to the relief body 201 and adjusts the load of the relief spring 204 in accordance with a press-fit and fixing position.

Here, when the fuel in the pressurizing chamber 11 is pressurized and the discharge valve 8b opens, the high-pressure fuel inside the pressurizing chamber 11 passes through the discharge valve chamber 12a and the fuel discharge passage 12b and is discharged from the fuel discharge port 12. The fuel discharge port 12 is formed in a discharge joint 60, and the discharge joint 60 is welded and fixed to the pump body 1 at a weld portion 61 to secure the fuel passage. In the present embodiment, the relief valve mechanism 200 is arranged in a space formed inside the discharge joint 60. That is, an outermost-diameter portion (in the present embodiment, an outermost diameter portion of the relief body 201) of the relief valve mechanism 200 is arranged on the inner circumferential side of an inner diameter portion of the discharge joint 60, and the relief valve mechanism 200 is arranged such that the relief valve mechanism 200 at least partially overlaps with the discharge joint 60 in its axial direction as the pump body 1 is viewed from above.

Incidentally, it is desirable that the relief valve mechanism 200 be inserted directly into the hole formed in the pump body 1 and arranged in a non-contact manner with the discharge joint 60. As a result, even if the shape of the discharge joint 60 is changed, it is not necessary to change the shape of the relief valve mechanism 200 in response to such a change so that it is possible to achieve cost reduction.

That is, a first hole 1c (lateral hole) is formed from the outer circumferential surface of the pump body 1 toward the inner circumferential side in a direction (lateral direction) orthogonal to the axial direction of the plunger in the present embodiment as illustrated in FIG. 1. Further, the relief valve mechanism 200 is arranged by press-fitting the relief body 201 into the first hole 1c (lateral hole). In the present embodiment, when the relief valve mechanism 200 opens in communication with the first hole 1c (lateral hole), a second hole 1d (vertical hole) for returning the fuel in the discharge-side flow path of the discharge valve 8b pressurized in the pressurizing chamber 11 to the damper chamber 10c is formed in the pump body 1.

More specifically, when the relief valve 202 opens, the discharge-side flow path (fuel discharge port 12) and an internal space of the relief body 201 communicate with each other. The relief valve holder 203, the relief spring 204, and the spring stopper 205 are arranged in this internal space. When the spring stopper 205 is viewed in the axial direction of the relief valve, a hole is formed in the center portion thereof, whereby the internal space of the relief body 201 and a relief passage 213 formed by the second hole 1d (vertical hole) are connected to each other. An end portion of the relief body 201 on a side where the spring stopper 205 is arranged is an opening portion, and the relief valve 202, the relief valve holder 203, the relief spring 204, and the spring stopper 205 are inserted in this order from this opening portion to form the relief valve mechanism 200.

The second hole (vertical hole) is formed from the outer circumference of the relief spring 204 toward the damper chamber 10c. Further, when the relief valve 202 opens, the fuel in the internal space of the relief body 201 flows into the damper chamber 10c through the hole in the center portion of the spring stopper 205, the opening portion of the relief body 201, and the relief passage 213.

When the high-pressure fuel supply pump is normally operating, the fuel pressurized by the pressurizing chamber 11 passes through the fuel discharge passage 12b and is discharged from the fuel discharge port 12 at a high pressure. In the present embodiment, a target fuel pressure of the common rail 23 is set to 35 MPa. The pressure inside the common rail 23 repeats pulsation over time, but an average value thereof is 35 MPa.

Immediately after start of a pressurization stroke, the pressure in the pressurizing chamber 11 sharply rises to rise above the pressure inside the common rail 23, and rises to about 43 MPa as a peak value in the present embodiment, and accordingly, the pressure of the fuel discharge port 12 also rises and rises to about 41.5 MPa at a peak in the present embodiment. In the present embodiment, a peak valve opening pressure of the relief valve mechanism 200 is set to 42 MPa, and the pressure of the fuel discharge port 12, which is an inlet of the relief valve mechanism 200, is set so as not to exceed the valve opening pressure, and the relief valve mechanism 200 does not open.

Next, a case where abnormally high pressure fuel is generated will be described.

If the pressure of the fuel discharge port 12 becomes abnormally high due to a failure of the electromagnetic intake valve 300 of the high-pressure fuel supply pump, and exceeds a set pressure of the relief valve mechanism 200 of 42 MPa, the abnormally high pressure fuel is relieved to the damper chamber 10c on the low pressure side via the relief passage 213.

An advantage of the configuration in which the abnormally high pressure fuel is relieved to the low pressure side (the damper chamber 10c in the present embodiment) will be described. It is possible to relieve the abnormally high pressure fuel generated due to the failure or the like of the high-pressure fuel supply pump to a low pressure in all steps of the intake stroke, the return stroke, and the discharge stroke. On the other hand, when the pressurizing chamber 11 is configured to relieve the abnormally high pressure fuel, it is possible to relieve the abnormally high pressure fuel to the pressurizing chamber 11 only in the intake stroke and the return stroke, and it is not allowed to relieve the abnormally high pressure fuel in the pressurization stroke. Since the outlet of the relief valve is the pressurizing chamber 11, the pressure in the pressurizing chamber 11 rises and a differential pressure between the inlet and the outlet of the relief valve does not become equal to or higher than a set pressure of the relief spring in the pressurization stroke. As a result, the time to relieve the abnormally high pressure fuel is shortened and the relief function deteriorates.

In the present embodiment, the relief valve mechanism 200 is assembled externally as a subassembly before being mounted to the pump body 1. After the assembled relief valve mechanism 200 is press-fitted and fixed to the pump body 1, the discharge joint 60 is welded and fixed to the pump body 1. Further, the present embodiment is configured such that at least a part of the relief valve mechanism 200 arranged in the first hole 1c (lateral hole) is arranged on the pressurizing chamber side (upper side in FIG. 1) with respect to an uppermost end portion 6b on the pressurizing chamber side of the cylinder 6 as illustrated in FIG. 1.

That is, when the entire relief valve mechanism 200 is positioned on the opposite side (lower side in FIG. 1) of the pressurizing chamber 11 with respect to the uppermost end portion 6b on the pressurizing chamber side of the cylinder 6, the pump body 1 between the relief valve mechanism 200 or the second hole 1d (vertical hole) and the cylinder 6 becomes thin. When the relief valve mechanism 200 opens, the abnormally high pressure fuel flows into the internal space of the relief body 201 and the second hole 1d (vertical hole). Therefore, from the viewpoint of reliability, it is important to increase the thickness of the pump body 1 between the relief valve mechanism 200 or the second hole 1d (vertical hole) and the cylinder 6 to some extent. Conversely, if this thickness is thin, the thickness between the pump body and the pressurizing chamber becomes thin, which leads to deterioration in reliability when the abnormally high pressure fuel flows.

Therefore, it is possible to secure this thickness by arranging the relief valve mechanism 200 as in the present embodiment described above, and to achieve the improvement in reliability. Incidentally, it is desirable to position the entire relief valve mechanism 200 on the upper side with respect to the uppermost end portion 6b on the pressurizing chamber side of the cylinder 6 as illustrated in FIG. 1 in order to secure the thickness of the relief valve mechanism 200 and the pressurizing chamber 11.

Further, it is desirable to arrange the relief valve mechanism 200 arranged in the first hole 1c (lateral hole) on the cylinder side (lower side in FIG. 1) of an uppermost end portion 11a on the opposite cylinder side (upper side in FIG. 1) of the pressurizing chamber 11 as illustrated in FIG. 1. More specifically, it is desirable to arrange the relief valve mechanism 200 between the uppermost end portion 11a on the opposite cylinder side of the pressurizing chamber 11 and the uppermost end portion 6b on the pressurizing chamber side of the cylinder 6.

In this manner, it is possible to provide the relief valve mechanism 200 on the same plane as the discharge joint 60, the electromagnetic intake valve mechanism 300, and the discharge valve mechanism 8, and to improve workability in terms of producing the pump body 1. More specifically, a central axis of the relief valve mechanism 200, that is, a central axis of the relief body 201, the relief valve holder 203, or the spring stopper 205 is arranged on a substantially straight line with a central axis of the electromagnetic intake valve mechanism 300 (rod 35). Therefore, it is possible to improve an assembly property of the high-pressure fuel supply pump.

Further, a position 1e at which an upper end portion of the first hole 1c (lateral hole) is connected to the second hole 1d (vertical hole) is arranged on the pressurizing chamber side (upper side in FIG. 1) with respect to the uppermost end portion 6b on the pressurizing chamber side of the cylinder 6 as illustrated in FIG. 1. Further, the position 1e at which the upper end portion of the first hole 1c (lateral hole) is connected to the second hole 1d (vertical hole) is desirably positioned on the lower side with respect to the uppermost end portion 11a on the opposite cylinder side of the pressurizing chamber 11. As a result, it is possible to secure the thickness of the pump body 1 between the relief valve mechanism 200 or the second hole 1d (vertical hole) and the cylinder 6, and thus, it is possible to secure the reliability while miniaturizing the fuel supply pump.

Incidentally, it is possible to easily form the relief passage 213 by forming the second hole 1d (vertical hole) downward from an opening portion 213a of the pump body 1 with respect to the first hole 1c (lateral hole) to communicate with the first hole 1c (lateral hole), in the present embodiment. In addition, the discharge joint 60 is arranged so as to cover the first hole 1c (lateral hole), and the relief valve mechanism 200 is arranged at the inner side of the discharge joint 60, and thus, it is possible to avoid size increases of the pump body 1 and the high-pressure fuel supply pump.

It is configured such that the entire relief passage 213 is formed on the inner circumferential side with respect to the outermost circumferential portion of the pressure pulsation reduction mechanism 9 as viewed from the axial direction of the plunger 2. As a result, it is possible to provide a configuration in which the abnormally high pressure fuel is released to a low-pressure passage 10c without increasing the size of the pump body 1. It is desirable to configure a diameter of the first hole 1c (lateral hole) to be larger than a diameter of the second hole 1d (vertical hole). Since the relief valve 200 is press-fitted into a bottom of the first hole 1c (lateral hole), a bottom surface of the first hole serves as a stopper of the relief valve 200.

Since the relief body 201 is provided in the present embodiment, the diameter of the first hole 1c (lateral hole) is the same as an outer diameter of the relief body. In addition, it is desirable to provide a configuration in which a diameter of a passage formed in the spring stopper 205 on the downstream side of the relief valve 202 becomes small with respect to the second hole 1d (vertical hole). The fuel released from the abnormally high pressure to the low pressure via the relief valve 200 has a large momentum, but this momentum can be decreased with the above configuration, and it is possible to prevent damage of the pressure pulsation reduction mechanism 9 and the other parts.

The second hole 1d (vertical hole) forming the relief passage 213 opens at the opening portion 213a to the damper chamber 10c housing the pressure pulsation reduction mechanism 9 that reduces low-pressure pulsation. Further, a holding member 9a configured to fix and hold the pressure pulsation reduction mechanism 9 is arranged between the opening portion 213a and the pressure pulsation reduction mechanism 9. The abnormally high pressure fuel is released through the relief passage 213. At that time, the fuel released from the opening portion 213a flows into the low-pressure passage 10c at high speed and collides with the holding member 9a. As a result, when the abnormally high pressure fuel is released to the low pressure, it is possible to avoid the problem that the pressure pulsation reduction mechanism 9 is damaged by the high speed.

Incidentally, an elastic portion 9b, which biases the planar portion flush with the opening portion 213a of the pump body 1 to bias the pressure pulsation reduction mechanism 9 toward the damper cover 14, is formed in the holding member 9a. More specifically, the holding member 9a is formed by pressing a single metal plate, and at this time, the elastic portion is formed by cutting and raising a part of a bottom portion of the holding member 9a toward the planar portion on the side of the opening portion 213a of the pump body. Further, when the damper cover 14 is attached to the pump body 1, the convex portion of the damper cover 14 biases the pressure pulsation reduction mechanism 9 toward the pump body 1, and as a result, the cut-and-raised portion 9b of the holding member 9a biases the planar portion of the pump body 1.

The cut-and-raised portion 9b of the holding member 9a biases a portion other than the opening portion 213a as the pump body 1 is viewed from above. As a result, since it is possible to reliably bring the cut-and-raised portion 9b of the holding member 9a and the pump body 1 into contact with each other, the pressure pulsation reduction mechanism 9 can be stably supported.

### Second Embodiment

Next, a second embodiment of the present invention will be described. The same reference signs as those in the first embodiment denote the same elements, and the description thereof will be omitted.

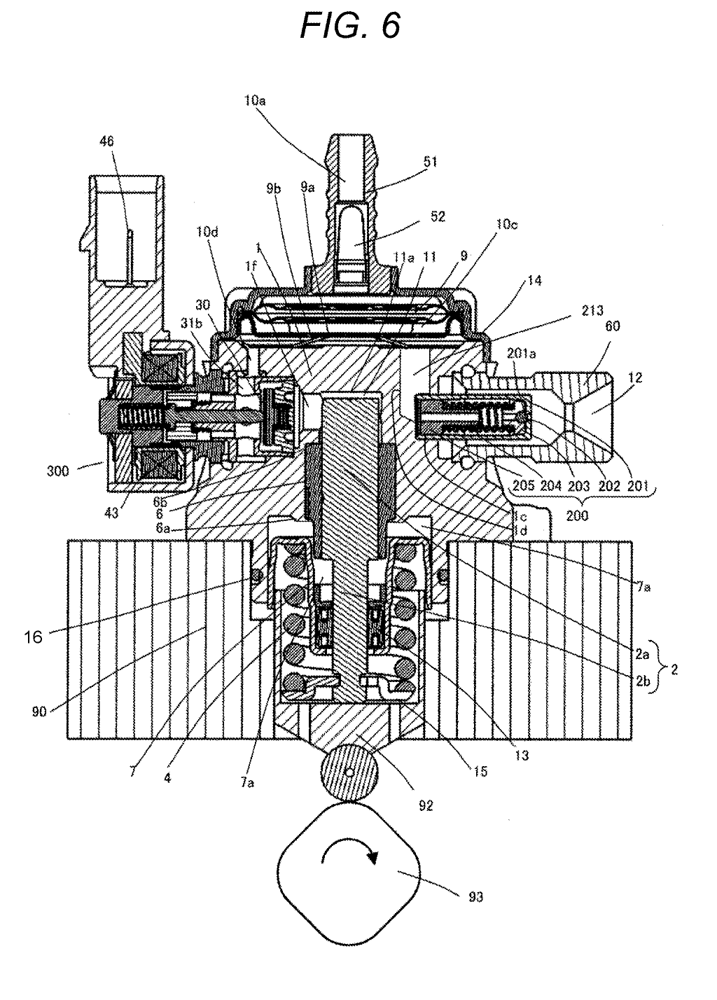

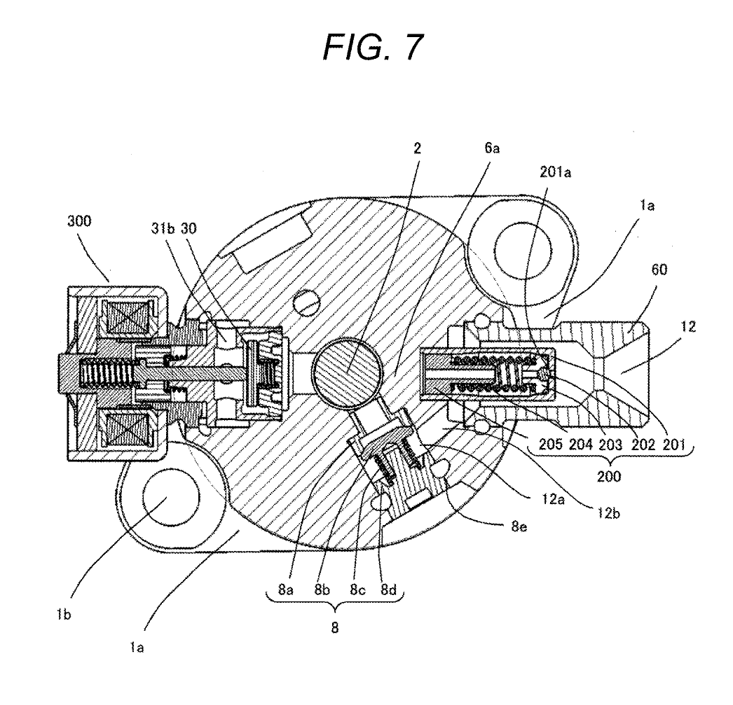

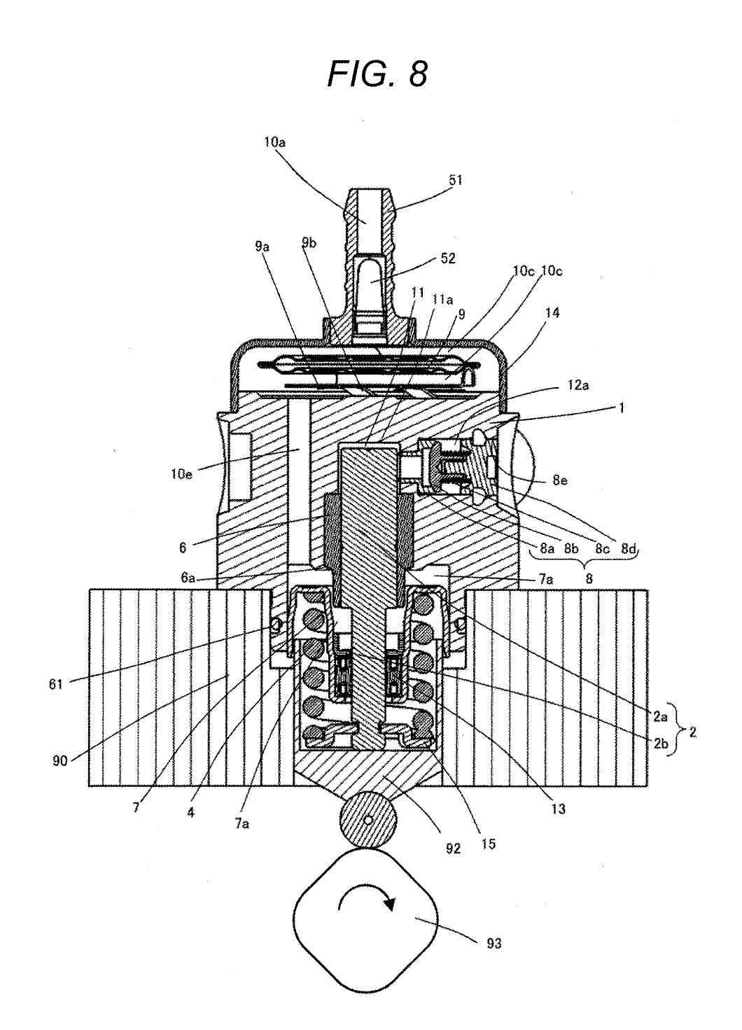

FIG. 6 is a vertical cross-sectional view of a high-pressure fuel supply pump of the present embodiment, and FIG. 7 is a horizontal cross-sectional view of the high-pressure fuel supply pump as viewed from above. Further, FIG. 8 is a vertical cross-sectional view of the high-pressure fuel supply pump viewed from a different direction from FIG. 6. Although the intake joint 51 is fixed to the pump body 1 in the first embodiment, the present embodiment is the high-pressure fuel supply pump in which the intake joint 51 is provided in the damper cover 14. The other points are the same as those in the first embodiment, and the same operations and effects as those in the first embodiment can also be obtained by the present embodiment.

### Third Embodiment

Next, a third embodiment of the present invention will be described. The same reference signs as those in the first embodiment denote the same elements, and the description thereof will be omitted.

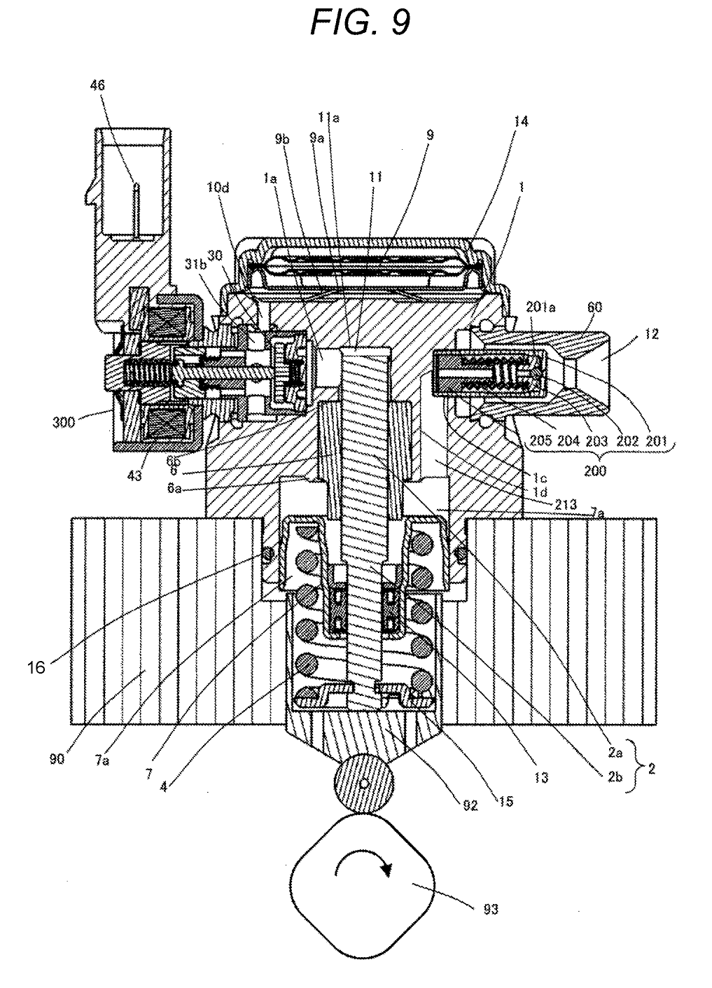

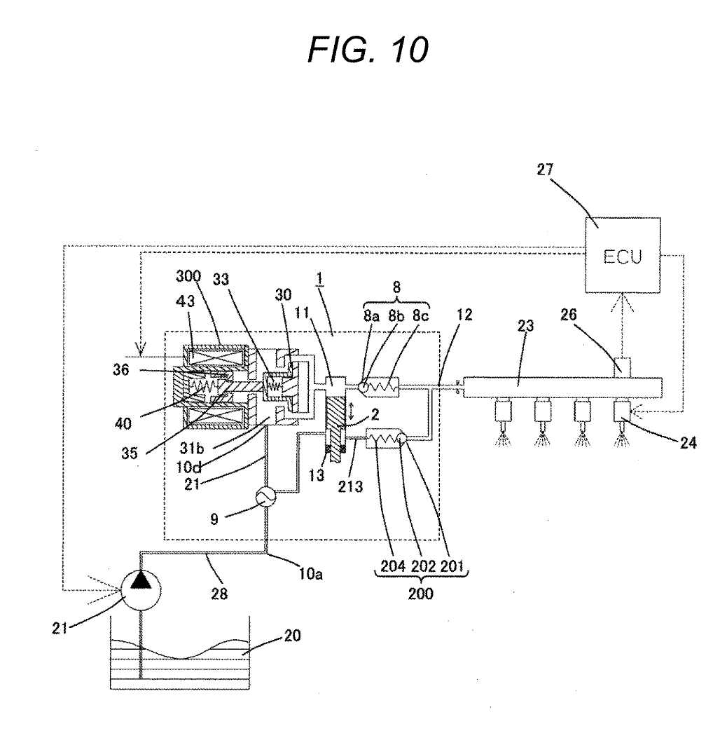

FIG. 9 is a vertical cross-sectional view of a high-pressure fuel supply pump of the present embodiment, and FIG. 10 is a block diagram of an engine system to which the high-pressure fuel supply pump according to the present embodiment is applied.

The first hole 1c (lateral hole) is formed from an outer circumferential surface of the pump body 1 toward the inner circumferential side in a direction (lateral direction) orthogonal to an axial direction of a plunger in the present embodiment as illustrated in FIG. 9. Further, the relief valve mechanism 200 is arranged by press-fitting the relief body 201 into the first hole 1c (lateral hole). In the present embodiment, when the relief valve mechanism 200 opens in communication with the first hole 1c (lateral hole), the second hole 1d (vertical hole) for returning the fuel in a discharge-side flow path of the discharge valve 8b pressurized in the pressurizing chamber 11 to the auxiliary chamber 7a communicating with the damper chamber 10c is formed in the pump body 1. That is, the second hole (vertical hole) is formed from an outer circumference of the relief spring 204 toward the auxiliary chamber 7a (plunger seal chamber). Although the second hole 1d (vertical hole) is formed from the upper side of the pump body 1 toward the lower side to communicate with the first hole 1c (lateral hole) in the first embodiment, the second hole 1d (vertical hole) is formed from the lower side of the pump body 1 toward the upper side to communicate with the first hole 1c (lateral hole) in the present embodiment. Although the relief passage 213 opens in the damper chamber 10c housing the pressure pulsation reduction mechanism 9 in the first embodiment, the relief passage 213 opens in the auxiliary chamber 7a in the present embodiment. The other points are the same as those in the first embodiment, and the same operations and effects as those in the first embodiment can also be obtained by the present embodiment.

Advantages of connection of an outlet of the relief valve 200 to the auxiliary chamber 7a as in the present embodiment will be described. First, there is an advantage that the degree of freedom of layout is high. Even when it is difficult or not allowed to connect an outlet of the relief valve 200 to the damper chamber 10c as in the first and second embodiments, there is a case where it is possible to connect the outlet to the auxiliary chamber 7a. Next, it is possible to prevent damage of the pressure pulsation reduction mechanism 9 when abnormally high pressure fuel is relieved to a low pressure. The fuel released from the abnormally high pressure to the low pressure via the relief valve 200 has a large momentum, and this fuel directly hits the pressure pulsation reduction mechanism 9 and serves as mechanism that damages the pressure pulsation reduction mechanism 9. However, there is no such a concern in the case of releasing to the auxiliary chamber 7a. This is because the fuel having the large momentum hits the seal holder 7 but the seal holder 7 is designed to have rigidity so as not to be damaged by the momentum of the fuel.

### Fourth Embodiment

Next, a fourth embodiment of the present invention will be described. The same reference signs as those in the first embodiment denote the same elements, and the description thereof will be omitted.

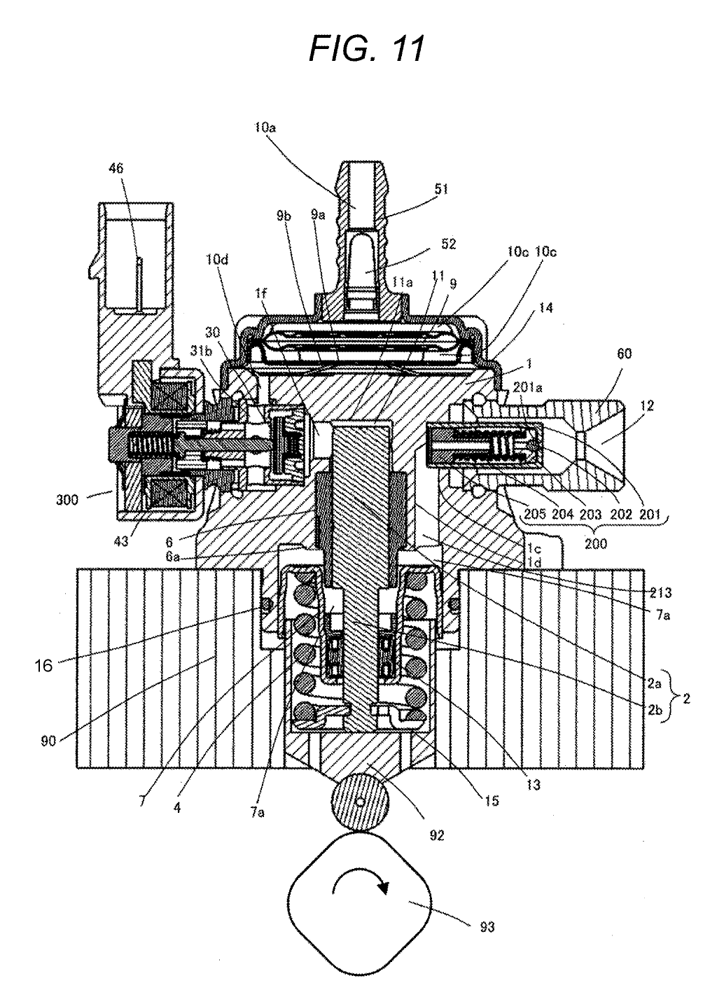

FIG. 11 is a vertical cross-sectional view of a high-pressure fuel supply pump of the present embodiment. Although the intake joint 51 is fixed to the pump body 1 in the third embodiment, the present embodiment is the high-pressure fuel supply pump in which the intake joint 51 is provided in the damper cover 14. The other points are the same as those in the first or third embodiment, and the same operations and effects as those in the first or third embodiment can also be obtained by the present embodiment.

### Fifth Embodiment

Next, a fifth embodiment of the present invention will be described. The same reference signs as those in the first embodiment denote the same elements, and the description thereof will be omitted.

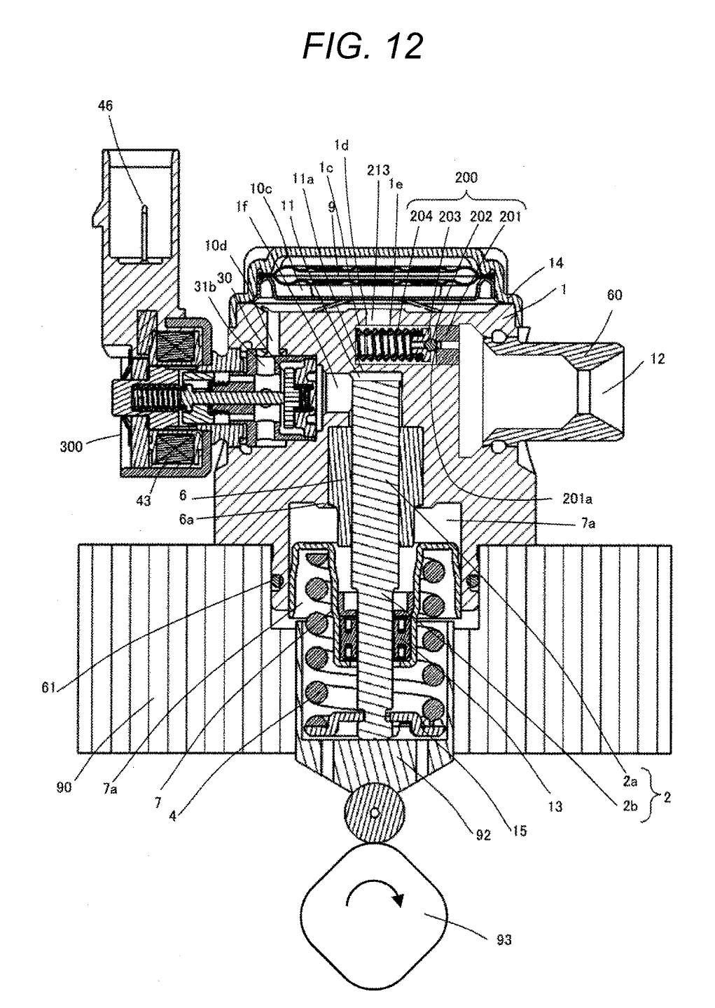

FIG. 12 is a vertical cross-sectional view of a high-pressure fuel supply pump of the present embodiment.

In the present embodiment, the relief valve 200 is not assembled as a subassembly, but it is configured such that the relief spring 204, the relief valve holder 203, the relief valve 202, and the relief body 201 are inserted in this order into the first hole 1c (lateral hole) of the pump body 1, and the relief body 201 is press-fitted and fixed to the pump body 1. A set pressure of the relief valve is adjusted by adjusting a set load of the relief spring 204 depending on the press-fitting position of the relief body 201 into the pump body 1. Thereafter, the discharge joint 60 is welded and fixed to the pump body 1.

In this configuration, the entire relief valve mechanism 200 constituted by the relief spring 204, the relief valve holder 203, the relief valve 202, and the relief body 201 is arranged on an opposite cylinder side (upper side in FIG. 12) of the end portion 11a on the opposite cylinder side of the pressurizing chamber 11. More specifically, it is desirable to arrange the relief valve mechanism 200 between the uppermost end portion 11a on the opposite cylinder side of the pressurizing chamber 11 and the damper chamber 10c.

Further, the position 1e at which the upper end portion of the first hole 1c (lateral hole) is connected to the second hole 1d (vertical hole) is desirably positioned on the upper side with respect to the uppermost end portion 11a on the opposite cylinder side of the pressurizing chamber 11 as illustrated in FIG. 12. Incidentally, it is desirable to form the second hole 1d (vertical hole) downward to be formed at a position overlapping with the pressurizing chamber 11 as the pump body 1 is viewed from above, in the present embodiment. As a result, in the case of producing both low-pressure return and high-pressure return of the relief valve mechanism 200, it is possible to easily manufacture the relief valve mechanism 200 only by changing a direction of forming the vertical hole of the pump body 1.

Incidentally, the second hole 1d (vertical hole) is connected to the damper chamber 10c in FIG. 12, but may be formed downward so as to be connected to the auxiliary chamber 7a from an outer circumference of the relief spring 204 or the low pressure chamber (intake passage 10d) in which the electromagnetic intake valve 300 is arranged. It is configured such that the relief passage 213 is formed on the inner circumferential side with respect to the outermost circumferential portion of the pressure pulsation reduction mechanism 9 as viewed from the axial direction of the plunger 2. As a result, it is possible to provide a configuration in which the abnormally high pressure fuel is released to a low-pressure passage 10c without increasing the size of the pump body 1.

### REFERENCE SIGNS LIST

1 pump body
2 plunger
6 cylinder
7 seal holder
8 discharge valve mechanism
9 pressure pulsation reduction mechanism
10a low-pressure fuel intake port
11 pressurizing chamber
12 fuel discharge port
13 plunger seal
30 intake valve
40 rod biasing spring
43 electromagnetic coil
100 pressure pulsation propagation prevention mechanism
101 valve seat
102 valve
103 spring
104 spring stopper
202 relief valve
201 relief body
203 valve holder
204 relief spring
205 spring stopper
300 electromagnetic intake valve mechanism

1. A high-pressure fuel supply pump comprising:
a plunger that changes a volume of a pressurizing chamber by reciprocating an inside of a cylinder;
a first hole formed from an outer circumferential surface of a pump body toward an inner circumferential side;
a relief valve mechanism arranged in the first hole; and
a second hole that returns fuel in a flow path on a discharge side of a discharge valve pressurized in the pressurizing chamber to a damper chamber or a plunger seal chamber communicating with the damper chamber when the relief valve mechanism opens in communication with the first hole,
wherein at least a part of the relief valve mechanism arranged in the first hole is arranged on a pressurizing chamber side with respect to an uppermost end portion on the pressurizing chamber side of the cylinder.

2. A high-pressure fuel supply pump comprising:
a plunger that changes a volume of a pressurizing chamber by reciprocating an inside of a cylinder;
a first hole formed from an outer circumferential surface of a pump body toward an inner circumferential side;
a relief valve mechanism arranged in the first hole; and
a second hole that returns fuel in a flow path on a discharge side of a discharge valve pressurized in the pressurizing chamber to a damper chamber or a plunger seal chamber communicating with the damper chamber when the relief valve mechanism opens in communication with the first hole,
wherein the relief valve mechanism arranged in the first hole is arranged on a cylinder side of an uppermost end portion on an opposite cylinder side of the pressurizing chamber.

3. A high-pressure fuel supply pump comprising:
a plunger that changes a volume of a pressurizing chamber by reciprocating an inside of a cylinder;
a first hole formed from an outer circumferential surface of a pump body toward an inner circumferential side;
a relief valve mechanism arranged in the first hole; and
a second hole that returns fuel in a flow path on a discharge side of a discharge valve pressurized in the pressurizing chamber to a damper chamber or a plunger seal chamber communicating with the damper chamber when the relief valve mechanism opens in communication with the first hole,
wherein a position where an upper end portion of the first hole is connected with the second hole is arranged on a pressurizing chamber side with respect to an uppermost end portion on the pressurizing chamber side of the cylinder.

4. The high-pressure fuel supply pump according to claim 1, wherein
a position where an upper end portion of the first hole is connected with the second hole is arranged on a cylinder side with respect to an uppermost end portion on an opposite cylinder side of the pressurizing chamber.

5. The high-pressure fuel supply pump according to claim 1, wherein
a discharge joint is attached so as to cover the first hole.

6. The high-pressure fuel supply pump according to claim 1, wherein
a diameter of a relief body in the first hole is configured to be larger than a diameter of the second hole.

7. The high-pressure fuel supply pump according to claim 1, wherein
the second hole has an opening toward a room in which a pressure pulsation reduction mechanism that reduces low-pressure pulsation is housed, and
a holding member, configured to hold the pressure pulsation reduction mechanism, is provided between the opening portion and the pressure pulsation reduction mechanism.

8. The high-pressure fuel supply pump according to claim 7, wherein
an elastic portion that biases the pressure pulsation reduction mechanism toward a damper cover is formed in the holding member, and
the elastic portion biases a planar portion of the pump body at a site other than the opening portion.

9. The high-pressure fuel supply pump according to claim 1, wherein
the second hole is formed on an inner circumferential side with respect to an outermost circumferential portion of the pressure pulsation reduction mechanism as viewed from an axial direction of the plunger.

10. The high-pressure fuel supply pump according to claim 1, further comprising
a relief spring that is arranged in the first hole and biases the relief valve,
wherein the second hole is formed from an outer circumference of the relief spring toward the damper chamber or the plunger seal chamber.

11. The high-pressure fuel supply pump according to claim 1, wherein
the relief valve mechanism is arranged between an uppermost end portion on an opposite cylinder side of the pressurizing chamber and the damper chamber.
